(19) United States
(12) Patent Application Publication
(10) Pub. No.: US 2020/0072343 A1
(43) Pub. Date: Mar. 5, 2020

(54) Gearshift Lever Device

(71) Applicant: FUJI KIKO CO., LTD., Shizuoka (JP)

(72) Inventors: Akio MATSUMOTO, Shizuoka (JP); Tomohiro TAKAHIRA, Shizuoka (JP); Katsushi KUBOTA, Shizuoka (JP); Yukihiro SATO, Shizuoka (JP); Takumi HAKAMATA, Shizuoka (JP)

(21) Appl. No.: 16/554,872

(22) Filed: Aug. 29, 2019

(30) Foreign Application Priority Data
Aug. 31, 2018 (JP) 2018-162604

(51) Int. Cl. F16H 59/02; F16H 59/10

(52) U.S. Cl. CPC F16H 59/0204; F16H 2059/026; F16H 59/10

(57) ABSTRACT

A gearshift lever device includes: a gearshift lever including an operation portion (knob) formed on an upper end portion and a shaft support portion formed on a lower end portion; and a select lever including a holding portion that holds the shaft support portion of the gearshift lever. The select lever further includes a pair of shift direction side wall portions which are disposed across the holding portion with a distance from each other in a shift direction of the gearshift lever, and engage portions which are disposed on the shift direction side wall portions and are to be engaged with the gearshift lever.

### CROSS REFERENCE TO RELATED APPLICATION

The present application is based on, and claims priority from Japanese Patent Application No. 2018-162604, filed Aug. 31, 2018, the disclosure of which is hereby incorporated by reference herein in its entirety.

### TECHNICAL FIELD

The present invention relates to a gearshift lever device.

### BACKGROUND ART

There has been known a gearshift lever device including a gearshift lever that is operated to shift relative to a main body case by a driver for gear change (see Japanese Patent Application Publication No. 2010-280349).

Some gearshift lever devices of this type include a gearshift lever including an operation portion formed on an upper end portion and a shaft support portion formed on a lower end portion and a select lever including a holding portion that holds the shaft support portion of the gearshift lever. In such gearshift lever device, a coupling piece is provided on a middle portion in an axial direction of the gearshift lever, and a coupling hole to be engaged with the coupling piece is formed in a side wall portion of the select lever.

### SUMMARY

In the gearshift lever device with the above-described configuration, the side wall portion of the select lever is arranged on one side in a select direction of the gearshift lever, and the side wall portion may be made thick so as to increase an area of engagement between the coupling piece and the coupling hole and increase the strength of the select lever. As the thickness of the side wall portion becomes larger, the thickness of the select lever in the select direction becomes larger accordingly, which may also result in increase of the size of the entire gearshift lever device.

In view of this, the object of the present invention is to suppress increase of the thickness in a select direction of a select lever and achieve downsizing of an entire gearshift lever device.

A gearshift lever device according to an aspect of the present invention includes: a gearshift lever including an operation portion formed on an upper end portion and a shaft support portion formed on a lower end portion; and a select lever including a holding portion that holds the shaft support portion of the gearshift lever. The select lever further includes a pair of shift direction side wall portions, which are disposed across the holding portion with a distance from each other in a shift direction of the gearshift lever, and engage portions, which are disposed on the shift direction side wall portions and are to be engaged with the gearshift lever.

According to a gearshift lever device of an aspect of the present invention, it is possible to suppress increase of the thickness in a select direction of a select lever and achieve downsizing of an entire gearshift lever device.

### BRIEF DESCRIPTION OF DRAWINGS

FIG. 1 is an exploded perspective view of a gearshift lever device according to an embodiment of the present invention.

FIG. 2 is a perspective view of a gearshift lever and a select lever in a state where the gearshift lever is shifted to a shift operation position.

FIG. 3 is a perspective view of the gearshift lever and the select lever in a state where the gearshift lever is shifted to a select operation position.

FIG. 4 is a perspective view of the gearshift lever and the select lever viewed from an opposite side of FIG. 2.

FIG. 5 is a plan view of a select lever plate.

FIG. 6 is a side view of the select lever plate.

### DESCRIPTION OF EMBODIMENTS

An embodiment of the present invention is described below in detail with reference to the drawings.

In the drawings, an arrow X indicates a select direction of a gearshift lever (vehicle right-left direction), an arrow Y indicates a shift direction of the gearshift lever (vehicle front-rear direction), and an arrow Z indicates an axial direction of the gearshift lever (vehicle top-down direction).

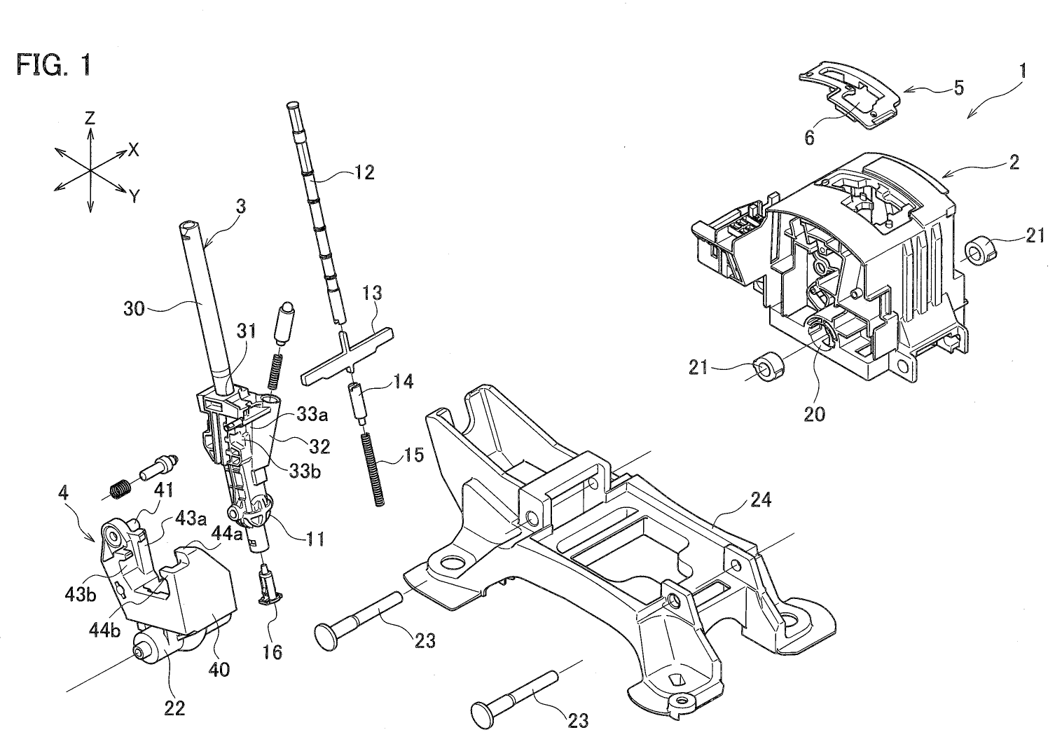

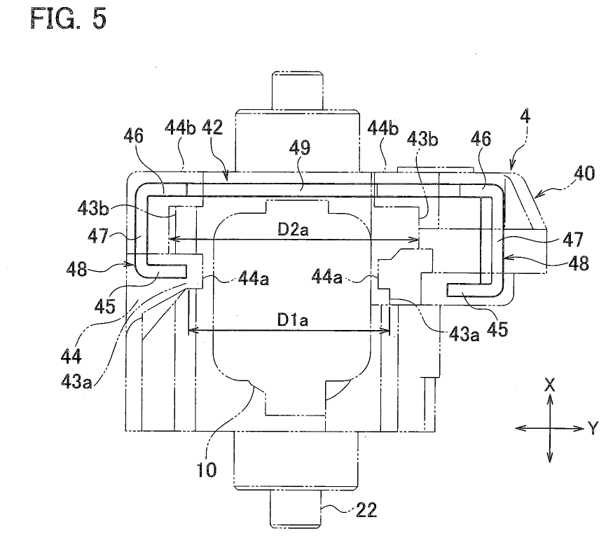

As illustrated in FIG. 1, the gearshift lever device 1 includes a main body case 2 fixed on a body (unillustrated) of the vehicle and a gearshift lever 3 and a select lever 4 that are supported by the main body case 2 in a shiftable manner (a swingable manner). The gearshift lever 3 includes an operation portion (knob) formed on an upper end portion (unillustrated) and a shaft support portion (spherical portion) 11 formed on a lower end portion. In the gearshift lever 3, a pushing rod 12, a position pin 13, an auxiliary rod 14, and a rod spring 15 are housed in this order from an upper end side of the gearshift lever 3, and a rod spring stopper 16 is attached on a lower end of the gearshift lever 3. On the other hand, the select lever 4 includes a holding portion 10 that holds the shaft support portion 11 of the gearshift lever 3 (see FIG. 5).

The gearshift lever 3 is supported to be shiftable (swingable) relative to the main body case 2 in the select direction (vehicle right-left direction) X and is supported to be shiftable relative to the main body case 2 in the shift direction (vehicle front-rear direction) Y. On the other hand, the select lever 4 is supported to be shiftable relative to the main body case 2 only in the shift direction (vehicle front-rear direction) Y.

In the select direction X, an A (automatic) mode and an M (manual) mode are set, for example. For operation positions in the shift direction Y during the A mode (shift operation positions), a P (parking) position, an R (reverse) position, and an N (neutral) position, and a D (drive) position are set, for example. For operation positions in the shift direction Y during the M mode (select operation positions), a shift-up position and a shift-down position are set, for example.

An indicator 5 that shows the operation positions of the gearshift lever 3 is arranged on the top of the main body case 2, and a gate hole 6 corresponding to the operation positions of the gearshift lever 3 is formed in the indicator 5.

A bearing portion 20 is formed in a lower portion of the main body case 2, and a support shaft 22 of the select lever 4 is rotatably supported by the bearing portion 20 with bearing collars 21. A block body (base bracket) 24 is assembled on the lower portion of the main body case 2 with locating pins 23.

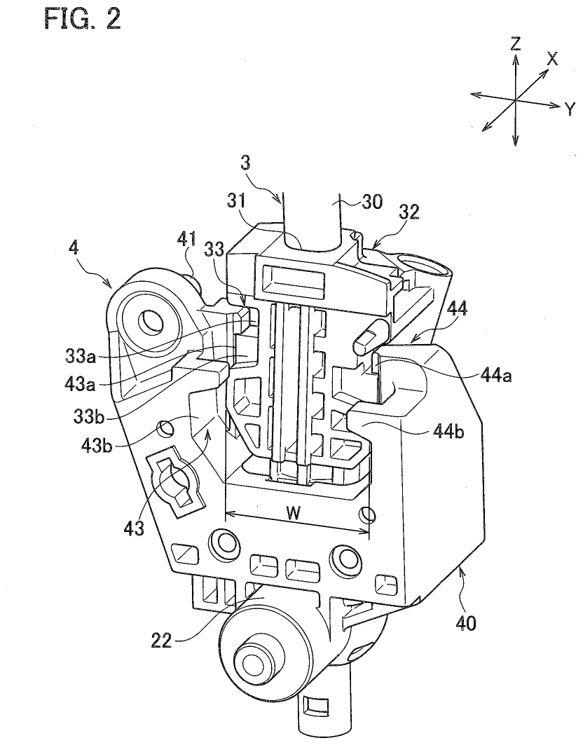

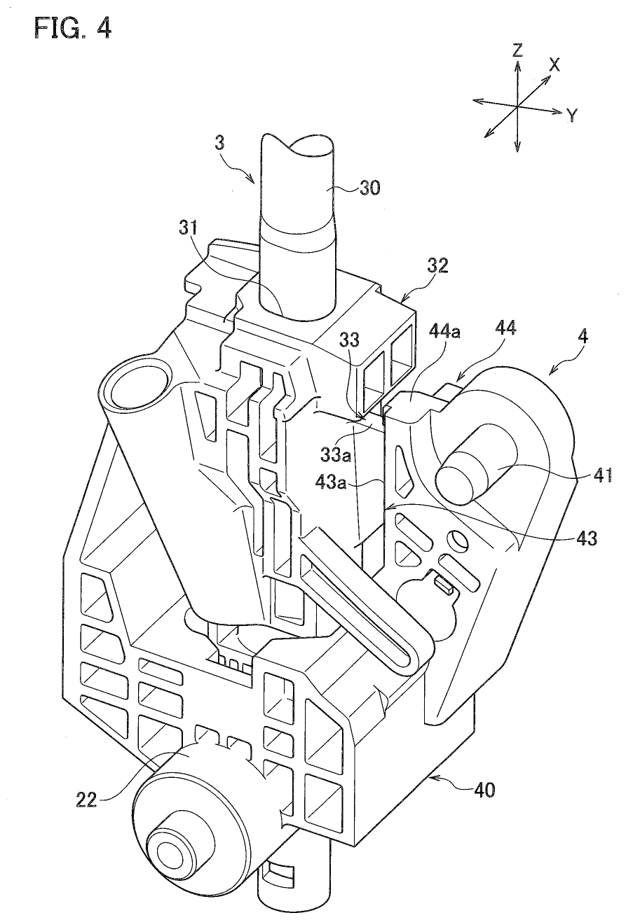

As illustrated in FIGS. 2 to 6, the gearshift lever 3 includes a tubular lever pipe (lever main body) 30 and a lever holder 32 having an insertion hole 31 through which the lever pipe 30 is inserted. The lever pipe 30 is made of metal, and the lever holder 32 is made of synthetic resin. The lever holder 32 may be formed by molding (to form a lever resin mold), and the lever pipe 30 may be pressed and fitted into the molded lever holder 32.

The select lever 4 includes a select lever main body 40 made of synthetic resin. A metallic cable pin 41 to which an unillustrated cable is to be connected and the later-described metallic select lever plate 42 are inserted in the synthetic resin select lever main body 40 by insert-molding. The cable pin 41 and the select lever plate 42 may be fixed on (or inserted in) the select lever main body 40 by a method other than the insert molding. Although it is not illustrated, the cable pin 41 and the select lever plate 42 may be molded integrally.

The select lever main body 40 further includes a pair of shift direction side wall portions 43, which are disposed across the holding portion 10 with a distance from each other in the shift direction Y of the gearshift lever 3, and engage portions (engage protrusions) 44, which are disposed on the shift direction side wall portions 43 and are to be engaged with the gearshift lever 3.

The shift direction side wall portions 43 include first shift direction side wall portions 43a disposed for the shift operation positions and second shift direction side wall portions 43b disposed for the select operation positions.

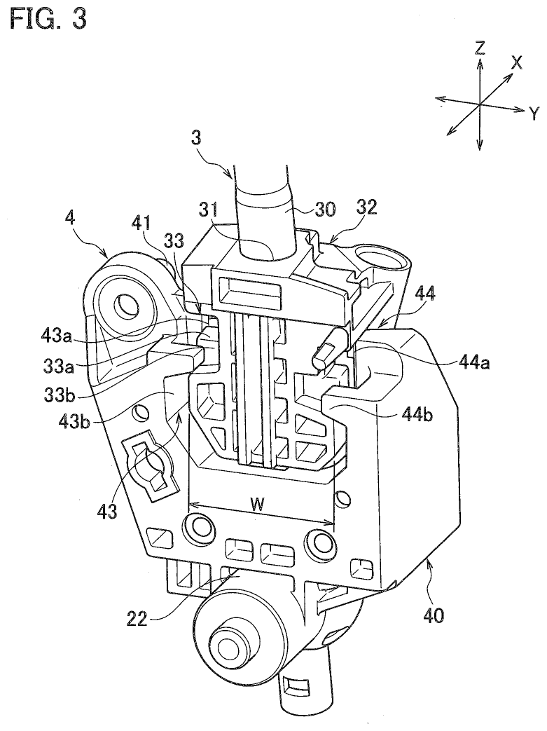

A distance D1a between the first shift direction side wall portions 43a, 43a (see FIG. 5) is almost equal to a width W of the lever holder 32 in the shift direction Y (see FIG. 2) such that the gearshift lever 3 and the select lever 4 shift together in the shift direction Y in any one of the shift operation positions. A distance D2a between the second shift direction side wall portions 43b, 43b (see FIG. 5) is longer than the width W of the lever holder 32 in the shift direction Y (see FIG. 3) such that only the gearshift lever 3 is shifted in the shift direction Y in any one of the select operation positions. Namely, the distance D1a between the first shift direction side wall portions 43a, 43a in the shift direction Y is shorter than the distance D2a between the second shift direction side wall portions 43b, 43b in the shift direction Y (see FIG. 5).

The engage portions 44 include first engage portions 44a engaged with the gearshift lever 3 in the shift operation position and second engage portions 44b engaged with the gearshift lever 3 in the select operation position which is displaced from the shift operation position in the select direction X of the gearshift lever 3. Namely, the first engage portions (first engage protrusions) 44a are formed on the first shift direction side wall portions 43a, and the second engage portions (second engage protrusions) 44b are formed on the second shift direction side wall portions 43b.

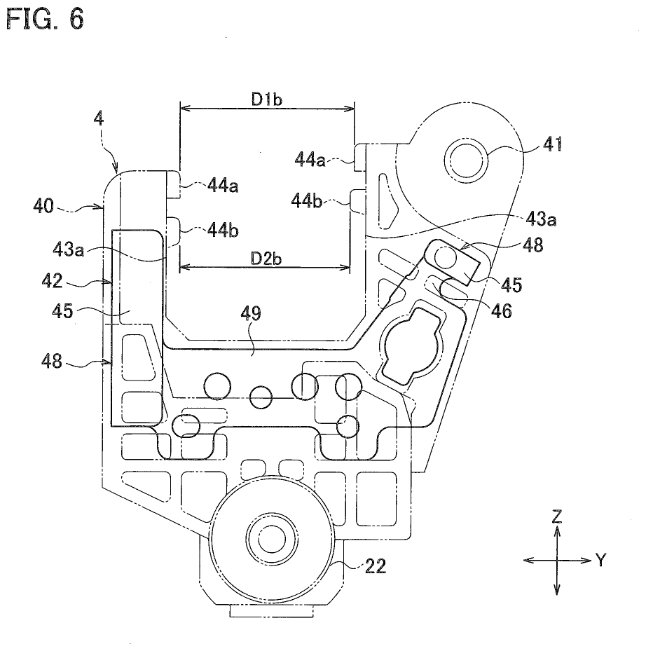

In this embodiment, a distance D1b between the first engage portions 44a, 44a in the shift direction Y is almost equal to a distance D2b between the second engage portions 44b, 44b (see FIG. 6). In this embodiment, positions of the first engage portions 44a and the second engage portions 44b in the axial direction Z with respect to the gearshift lever 3 are different, and specifically, the first engage portions 44a are positioned higher than the second engage portions 44b (see FIGS. 2 and 3).

On the other hand, the gearshift lever 3 includes engage recesses 33, which are formed in parts of the lever holder 32 of the gearshift lever 3 facing the shift direction side wall portions 43 in the shift direction Y of the gearshift lever 3 to be engaged with the engage portions 44.

The engage recesses 33 include first engage recesses 33a engaged with the first engage portions 44a of the select lever 4 in the shift operation position and second engage recesses 33b engaged with the second engage portions 44b of the select lever 4 in the select operation position.

In this embodiment, positions of the first engage recesses 33a and the second engage recesses 33b in the axial direction Z with respect to the gearshift lever 3 are different, and specifically, the first engage recesses 33a are positioned higher than the second engage recesses 33b (see FIGS. 2 and 3).

Such a gearshift lever 3 is inserted to the holding portion 10 of the select lever 4 from obliquely above so as to avoid interference with the engage portions 44 (first engage portions 44a and second engage portions 44b).

As illustrated in FIGS. 5 and 6, the select lever 4 includes the select lever main body 40 in which the first engage portions 44a and the second engage portions 44b are formed and the select lever plate 42 for reinforcement inserted in the select lever main body 40.

The select lever plate 42 includes first plate portions (turn-back portions) 45 that reinforce the first engage portions 44a and second plate portions 46 that reinforce the second engage portions 44b. The select lever plate 42 is formed to have U-shapes, further including connecting portions 47 that are arranged to extend along the select direction X of the gearshift lever 3 and connect the first plate portions 45 and the second plate portions 46.

A pair of U-shape portions 48 formed in the U-shapes are disposed across the holding portion 10 with a distance from each other in the shift direction Y of the gearshift lever 3. The pair of U-shape portions 48, 48 (second plate portions 46, 46) are joined with each other by a coupling portion 49 arranged to extend along the shift direction Y of the gearshift lever 3.

As illustrated in FIG. 2, in the A mode (in a state where the gearshift lever 3 is shifted to the shift operation position), the first engage portions 44a of the select lever 4 and the first engage recesses 33a of the gearshift lever 3 are engaged with each other. Consequently, the first engage portions 44a of the select lever 4 serve as stoppers (retainers), and prevent the gearshift lever 3 from moving upward and getting out of the holding portion 10 of the select lever 4. When the gearshift lever 3 is shifted in the shift direction Y with the gearshift lever 3 shifted to the shift operation position, the gearshift lever 3 and the select lever 4 are shifted in the shift direction Y together.

As illustrated in FIG. 3, in the M mode (in a state where the gearshift lever 3 is shifted to the select operation position), the second engage portions 44b of the select lever 4 and the second engage recesses 33b of the gearshift lever 3 are engaged with each other. Consequently, the second engage portions 44b of the select lever 4 serve as the stoppers (retainers), and prevent the gearshift lever 3 from moving upward and getting out of the holding portion 10 of the select lever 4. When the gearshift lever 3 is shifted in the shift direction Y with the gearshift lever 3 shifted to the select operation position, only the gearshift lever 3 is shifted in the shift direction Y.

Operations and effects of this embodiment are described below.

(1) The gearshift lever device 1 includes the gearshift lever 3 including the operation portion (knob) formed on the upper end portion and the shaft support portion 11 formed on the lower end portion, and the select lever 4 including the holding portion 10 that holds the shaft support portion 11 of the gearshift lever 3. The select lever 4 further includes the pair of shift direction side wall portions 43, which are disposed across the holding portion 10 with a distance from each other in the shift direction Y of the gearshift lever 3, and the engage portions 44, which are disposed on the shift direction side wall portions 43 and are to be engaged with the gearshift lever 3.

In the select lever 4, the pair of shift direction side wall portions 43, 43 are disposed across the holding portion 10 with the distance from each other in the shift direction Y, and additionally, the engage portions 44 are to be engaged with the gearshift lever 3 are disposed on the shift direction side wall portions 43. Since the thickness (width in select direction X) of the select lever 4 does not need to be increased in such a configuration of the select lever 4, it is possible to achieve downsizing of the entire gearshift lever device 1.

(2) The gearshift lever 3 includes the engage recesses 33, which are formed in the parts of the gearshift lever 3 facing the shift direction side wall portions 43 in the shift direction Y of the gearshift lever 3 to be engaged with the engage portions 44.

Since the thickness (width in select direction X) of the gearshift lever 3 does not need to be increased as well in such a configuration of the gearshift lever 3, it is possible to achieve downsizing of the entire gearshift lever device 1.

(3) The engage portions 44 include the first engage portions 44a engaged with the gearshift lever 3 in the shift operation position and the second engage portions 44b engaged with the gearshift lever 3 in the select operation position which is displaced from the shift operation position in the select direction X of the gearshift lever 3.

With such a configuration of the engage portions 44, it is possible to prevent the gearshift lever 3 from moving in the axial direction Z (vehicle top-down direction) and prevent the shaft support portion 11 of the gearshift lever 3 from getting out of the holding portion 10 of the select lever 4.

(4) The select lever 4 includes the select lever main body 40 in which the first engage portions 44a and the second engage portions 44b are formed and the select lever plate 42 for reinforcement inserted in the select lever main body 40. The select lever plate 42 includes the first plate portions 45 that reinforce the first engage portions 44a and the second plate portions 46 that reinforce the second engage portions 44b. The select lever plate 42 is formed to have U-shapes, further including the connecting portions 47 that are arranged to extend along the select direction X of the gearshift lever 3 and connect the first plate portions 45 and the second plate portions 46.

With such a configuration of the select lever 4, it is possible to achieve improvement of the strength of the select lever 4 (select lever main body 40).

Although the gearshift lever device of the present invention is described taking the above-described embodiment as an example, it is not limited to the above-described embodiment, and various other embodiments can be employed without departing from the gist of the present invention.

What is claimed is:

1. A gearshift lever device, comprising:
a gearshift lever including an operation portion formed on an upper end portion and a shaft support portion formed on a lower end portion; and
a select lever including a holding portion that holds the shaft support portion of the gearshift lever, wherein
the select lever further includes a pair of shift direction side wall portions which are disposed across the holding portion with a distance from each other in a shift direction of the gearshift lever, and engage portions which are disposed on the shift direction side wall portions and are to be engaged with the gearshift lever.

2. The gearshift lever device according to claim 1, wherein
the gearshift lever includes engage recesses which are formed in parts of the gearshift lever facing the shift direction side wall portions in the shift direction of the gearshift lever and are to be engaged with the engage portions.

3. The gearshift lever device according to claim 1, wherein
the engage portions include first engage portions engaged with the gearshift lever in a shift operation position and second engage portions engaged with the gearshift lever in a select operation position which is displaced from the shift operation position in a select direction of the gearshift lever.

4. The gearshift lever device according to claim 1, wherein
the select lever includes a select lever main body in which first engage portions and second engage portions are formed, and a select lever plate for reinforcement inserted in the select lever main body, and
the select lever plate is formed to have U-shapes, including first plate portions that reinforce the first engage portions, second plate portions that reinforce the second engage portions, and connecting portions that are arranged to extend along a select direction of the gearshift lever and connect the first plate portions and the second plate portions.
